(19) United States
(12) Patent Application Publication
(10) Pub. No.: US 2022/0276347 A1
(43) Pub. Date: Sep. 1, 2022

(54) LIGHT DETECTION AND RANGING SYSTEM

(71) Applicant: Intel Corporation, Santa Clara, CA (US)

(72) Inventors: Naresh SATYAN, Pasadena, CA (US); Yaakov VILENCHIK, Jerusalem (IL); Ron FRIEDMAN, Givat Oz (IL); Israel PETRONIUS, Haifa (IL); Shachar GREENBERG, Nofit (IL)

(21) Appl. No.: 17/546,097

(22) Filed: Dec. 9, 2021

(51) Int. Cl. G01S 7/481; G01S 7/4915; G01S 7/4913; G01S 7/499; G01S 7/493

(52) U.S. Cl. CPC G01S 7/4817; G01S 7/4915; G01S 7/4913; G01S 7/499; G01S 7/493

(57) ABSTRACT

A light detection and ranging (LIDAR) system, including: a laser source configured to emit one or more optical beams; at least one optical channel configured to emit the one or more optical beams from an optical output interface of the optical channel over a scene and capture reflections of the one or more optical beams from the scene in an optical input interface of the optical channel; wherein the one or more optical beams are scanned in a first direction, and wherein the optical input interface and the optical output interface are arranged along a second direction different from the first direction, and wherein the optical channel comprises a polarization beam displacer configured to guide reflections of the one or more beams from a receiving position arranged along the first direction towards the optical input interface.

### TECHNICAL FIELD

This disclosure generally relates to light detection and ranging systems.

### BACKGROUND

Long-range light detection and ranging (LIDAR) systems for self-driving and autonomous vehicles require a wide field of view (FOV), a large number of pixels measured at high speed, e.g. a high resolution, and a large number of points per second, to ensure detection of small road hazards. The requirements are evolving, but the market trends towards requiring more than 1 million points per second (MPPS), reaching up to 5-10 MPPS or more. A measurement rate of 1 MPPS means that the average time to measure a pixel is 1 microsecond (μs). If a single optical beam is scanned across a scene in a scanning LIDAR configuration, a requirement of 1 MPPS translates to a measurement time or a “pixel time” of 1 μs. However, it takes light some time to travel to the target and back. As an example, for a target at a distance of 200 m, the return signal from the target only arrives 1.3 μs after the transmitted light is launched towards the target.

In coherent LIDAR systems of the related art, the return signal from the target mixes with a “local oscillator” signal. Typically, the LIDAR system transmits a linearly chirped optical waveform to the target, and the local oscillator is a copy of the transmitted waveform. The chirp consists of an up-chirp and a down-chirp to measure both range and range-rate of the target. The problem with a long round-trip time, e.g. 1.3 μs in the example, is that the return signal arrives when there is not a copy of the transmitted signal available to act as the local oscillator for coherent LIDAR detection. This temporal delay is also denoted as temporal skew.

In a frequency modulated continuous wave (FMCW) LIDAR system of the related art, a modulation waveform that is longer in time than a single pixel time resolves the temporal skew.

In a scanning LIDAR system of the related art, e.g. a coherent LIDAR system or time-of-flight (TOF) LIDAR system, it is desirable that the return signal from the target passes through the same scanning optic that distributes the transmitted beam to the target. This so-called “through the mirror” configuration ensures that the receiver is only sensitive to light from the part of the scene that is illuminated, and not unwanted interference. In a fast scanning system, the mirror directs light to the next pixel after a “pixel time”. If the pixel time is comparable, or smaller than the round-trip time of light, there is a spatial separation between the transmitted and received beams. This spatial separation is also denoted as “point-ahead error”.

A LIDAR system of the related art uses parallelization to eliminate the point-ahead error. Here, as an example, the LIDAR system uses 10 parallel channels to measure 10 pixels simultaneously. The pixel time per channel is 10 μs to obtain an average pixel time of 1 μs. The larger pixel time reduces the point-ahead error. However, the LIDAR system using parallelization with a large number of channels can increase cost.

Another LIDAR system of the related art uses “lagging detectors”. Here, the receiver is tuned to a target return in a different spatial location A multiplicity of detectors measures the target return, some of which are arranged in spatially separate locations compared from the transmit path. These detectors “lag” the transmit beam along the direction of the fast mechanical scan. Illustratively, the detectors look for return signals from pixels that were illuminated at a previous instant in time. Depending on the angular scan speed, angular resolution and the target range, the target return signal arrives in different spatial locations, and multiple lagging detectors are used, each one corresponding to a subset of target ranges. If the scan is repeated in the opposite direction, lagging detectors will be required on the other side of the transmit channel. However, a photonic integrated circuit platform is necessary in this LIDAR system to reduce cost but this limits the scalability for a parallel multichannel configuration.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 to FIG. 5 illustrate schematic diagrams of optical input and output interfaces of LIDAR systems;

FIG. 6 illustrates a schematic diagram of a LIDAR system;

FIG. 7 illustrates a exemplary flow chart of the polarization state of light in an optical channel of the LIDAR system; and

FIG. 8 illustrates a vehicle having a LIDAR system.

### DESCRIPTION

The following detailed description refers to the accompanying drawings that show, by way of illustration, specific details and examples in which the disclosure may be practiced. One or more examples are described in sufficient detail to enable those skilled in the art to practice the disclosure. Other examples may be utilized and structural, logical, and electrical changes may be made without departing from the scope of the disclosure. The various examples described herein are not necessarily mutually exclusive, as some examples can be combined with one or more other examples to form new examples. Various examples are described in connection with methods and various examples are described in connection with devices. However, it may be understood that examples described in connection with methods may similarly apply to the devices, and vice versa. Throughout the drawings, it should be noted that like reference numbers are used to depict the same or similar elements, features, and structures. Throughout the drawing, it should be noted that a direction may indistinguishably include positive and negative direction of the direction despite different depicted directions if the direction is not explicitly distinguished.

Illustratively, a LIDAR system using a photonic integrated circuit (PIC) includes a plurality of parallel optical channels spanning one direction of the LIDAR field of view, e.g. the vertical direction, while the LIDAR system scans the beam mechanically in another direction of the LIDAR field of view, e.g. the horizontal direction. As an example, the point-ahead error may be in the horizontal direction, while the plurality of optical channels may be oriented along the vertical direction. A polarization diversity optic of the LIDAR system outside the PIC diversions the light from the target with point-ahead error back to the direction of the PIC. Illustratively, the polarization diversity optic provides that light transmitted from the LIDAR system to the target and light received from the target at the LIDAR system have different polarization directions. Further, the polarization diversity optic deflects the beam, and, thus, the beam from the target received at the LIDAR system arrives at a separate spatial location compared to the beam transmitted from the LIDAR system to the target. This way, a LIDAR system having a large number of points per second and fine (x, y) resolution provides detection of small road hazards such as pedestrians, tires, debris etc. at long ranges. The LIDAR system provides lower cost and complexity compared to LIDAR systems of the related art.

In other words, the LIDAR system may include a photonic integrated circuit with one or more of optical channels. The LIDAR system may be configured to physical separate the one or more optical transmit channels from the respective optical receive channel by use of the polarization diversity optic to provide different polarizations for the optical transmit channel and the optical receive channel, respectively. As an example, the LIDAR system may be a FMCW LIDAR system using a photonic integrated circuit (PIC). This way, the LIDAR system provides a two-directional arrangement of LIDAR transmitters and receivers, and provides efficient collection of light from all application specific target ranges.

Thus, a LIDAR system utilizing a PIC, e.g. a TOF LIDAR system or a coherent LIDAR system as further examples, provides higher performance at lower cost. The PIC-based LIDAR system provides efficient mixing of the optical return signal with a Local Oscillator (LO) on the PIC. In addition, the LIDAR system provides imaging rates well beyond 1 MPPS, and provides long-range performance. The LIDAR system includes a parallel architecture having a plurality of parallel optical channels simultaneously scanned across a scene. If there are N channels (N>=1) operating at a 1 μs pixel time, the overall imaging rate of the system is larger at N MPPS. Due to complexities of the mechanical architecture, the N channels may be arranged along a direction perpendicular to the axis of the fast mechanical scan. For example, the channels are arranged along the vertical axis while the beams are scanned fast along the horizontal axis. Wavelength multiplexing can be used in addition to improve the vertical resolution of the system.

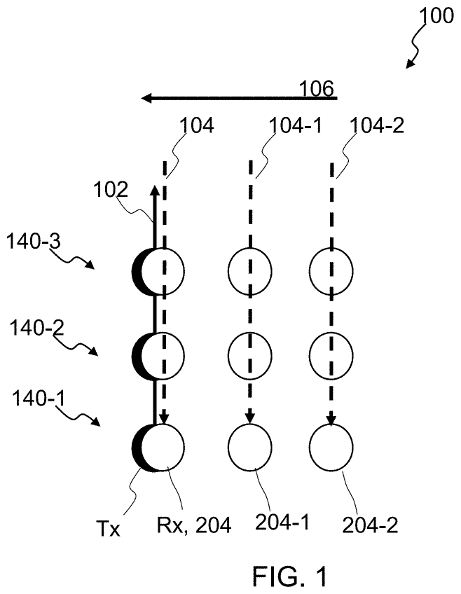

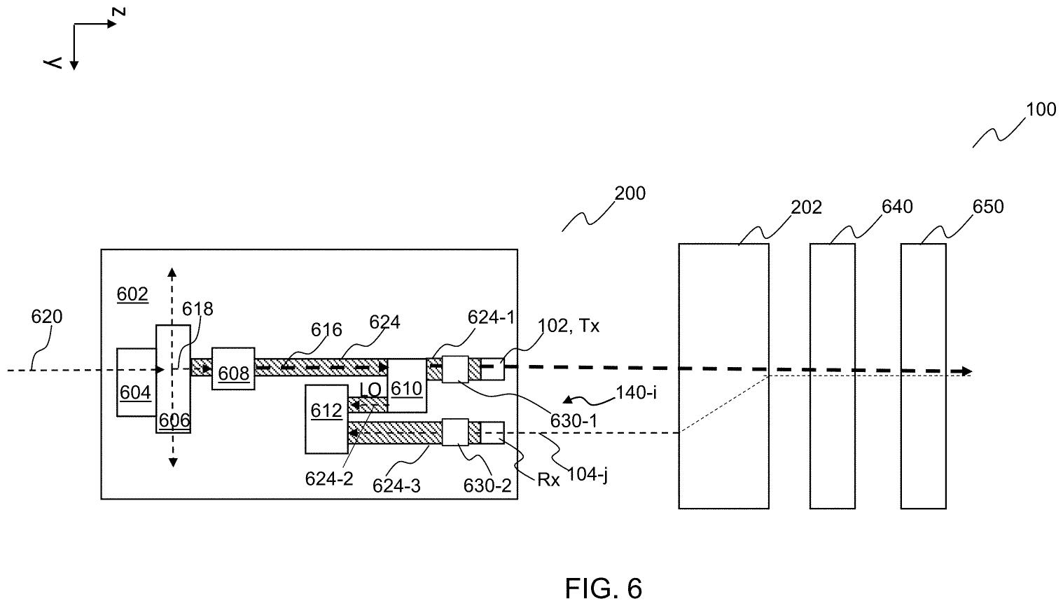

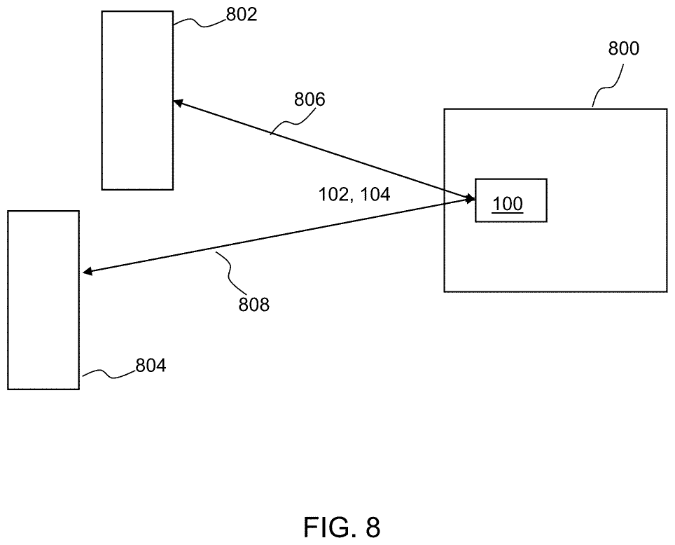

FIG. 1 to FIG. 5 illustrate schematic diagrams of optical input/output interfaces of LIDAR systems. The LIDAR system is illustrated in more detail in FIG. 6, and an application example of the LIDAR system is illustrated in FIG. 8.

FIG. 1 illustrates a schematic diagram of an optical input/output interface of a LIDAR system 100, e.g. top view as seen from the target(s) of the LIDAR system 100. The LIDAR system 100 includes one or more optical channels 140-i (with i being one of 1 to N, and N being the total number of optical channels of the LIDAR system), wherein FIG. 1 shows three optical channels 140-1, 140-2, 140-3.

Each optical channel 140-i includes an optical output interface Tx configured to emit light 102 from the LIDAR system to a scene outside the LIDAR system 100.

Each optical channel 140-i includes an optical input interface Rx configured to receive light 104, 104-1, 104-2 from the scene outside the LIDAR system 100.

Targets in the scene back reflect light 104 to the LIDAR system 100 that was emitted from the LIDAR system previously. Thus, returned light 104 is based or arranged along the emitted light 102, but in opposite direction. The returned light 104 may include the point-ahead error described above. FIG. 1 illustrates the point-ahead error by the different light receiving positions 204, 204-1, 204-2. The light receiving position may be a spot on a surface of the PBD receiving the light reflected from the scene. In other words, returned light 104 having the point-ahead error return at light receiving positions 204-1, 204-2 to the right of the optical output interface Tx. Targets farther away from the LIDAR system provide a larger point-ahead error and have light receiving positions 204-1, 204-2 having an (larger) offset from the optical output interface Tx than closer targets. In other words, light 104-2 returning to a second light receiving position 202-2 includes a larger point-ahead error than light 104-1 returning to a first light receiving position 202-1. As such, the target back reflecting the first light 104-1 is closer to the LIDAR system 100 than the target back reflecting the second light 104-2.

The optical input interface Rx may receive the returned light at different positions per optical channel (in FIG. 1 illustrated by the different return lights 104, 104-1, 104-2) via the polarization diversity optic as described in more detail below. In other words, each of the return lights 104, 104-1, 104-2 correlates to a different range, e.g. a distance between the optical output interface and the back reflecting object (target) in the scene of the LIDAR system 100. However, each of the returned lights 104, 104-1, 104-2 may correlate to the same LO and, hence, may be provided via the polarization diversity optic to the photo detector providing this LO.

In other words, the LIDAR system 100 may scan the emitted beam 102 over the scene, e.g. using optical components, e.g. a scan mirror (not illustrated). In FIG. 1, the scan direction is illustrated via arrow 106. The scan direction 106 may be a first direction and the optical channels 140-i, e.g. the optical output interfaces Tx, may be arranged in a second direction that is different from the first direction. As an example, the scan direction (first direction) 106 may be vertical and the optical output interfaces Tx may be arranged horizontally (second direction). However, the scan direction 106 and the alignment direction of the optical output interfaces Tx may also include an angle different from 90°, e.g. being non-perpendicular.

In FIG. 1, a common positioning line (also denoted as positioning direction) may include the optical output interfaces Tx of the optical channels. The common positioning line may be about perpendicular to the scan direction 106, as an example. The common positioning line may be a physical structure, e.g. an edge of a PIC or a waveguide structure.

As an example, the LIDAR system 100 may have a plurality of optical channels 140-i having optical output interfaces (also denoted as transmitters) Tx and optical input interfaces (also denoted as receivers) Rx located on the surface of a PIC. In this case, the circular shapes shown in FIG. 1 illustrate interfaces between the PIC and the scene in the outside of the LIDAR system that emit light from a waveguide (transmitter), or couple light into a waveguide (receiver channel) which is then mixed with a local oscillator (LO) on to a photo detector (see also FIG. 6). When vertically emitting optical output interfaces Tx are used, the LIDAR system 100 may include a plurality of similar light receiving position 204, 204-1, 204-2 arranged along a common line per range respectively, as illustrated in FIG. 1.

In other words, FIG. 1 may illustrate point-ahead errors in a multichannel LIDAR system with multiple vertical channels that may operate simultaneously. The transmitters Tx and receivers Rx may be vertical optical interfaces on the PIC. The emitted beams 102 and returned Rx beams 104, 104-1, 104-2 are shown in the plane of the PIC of a LIDAR system 100 for convenience, but actually come out of the plane of the LIDAR system 100. Each receiver Rx measures a subset of target ranges through different light receiving positions 204, 204-1, 204-2 from a pixel in the scene of the LIDAR system 100 illuminated from its corresponding transmitter Tx. One direction of scan 106 is shown for clarity. However, the scan can be bidirectional, into the opposite direction, or any other direction.

As an example, the LIDAR system 100 may include vertical emitting interfaces Tx, e.g. based on gratings or mode couplers. Alternatively, or in addition, the LIDAR system includes edge-emitting interfaces. Edge-emitting interfaces may allow to better control parasitic reflections of light from the interface Tx. The edge-emitting interfaces Tx of the PIC may be arranged in one direction (here, vertical direction or second direction). The two-directional arrangement of transmitters Tx and light receiving positions 204, 204-1, 204-2 shown in FIG. 1 be mapped on to a single direction, e.g. along Rx arranged among Tx. However, a spatial separation between the transmitted beams 102 and received beams 104 may be maintained. This way, cross-talk, e.g. interference, between transmitted beams and received beams 104 may be reduced.

A polarization beam displacer (PBD), e.g. in combination with a polarization diversity optics, in the optical channel may separate polarizations of the transmitted beams 102 and received beams 104. This way, the PBD may perform a two-direction (2D), e.g. light from targets at different ranges, to one-direction (1D) mapping, e.g. at a common one photo detector for each of the optical channels respectively.

The polarization diversity optic may include a Faraday rotator and/or a waveplate, e.g. a quarter waveplate, or a Faraday rotator and a half waveplate, as an example. The polarization diversity optics arranged in the beam path of the emitted light 102 and in the beam path of the back reflected light 104 may turn the polarization of at least the light received at the light receiving position 204-1, 204-2 relative to the polarization emitted from the optical output interface Tx. This way, the PBD diverts the returned beam 104, 104-1, 104-2 relative to the transmitted beam 102. The polarization diversity optics may also turn the polarization of the transmitted light between the scene and the optical output interface Tx. The light received at the optical input interface may be combined with a local oscillator signal to determine a range or range rate to the back reflecting target.

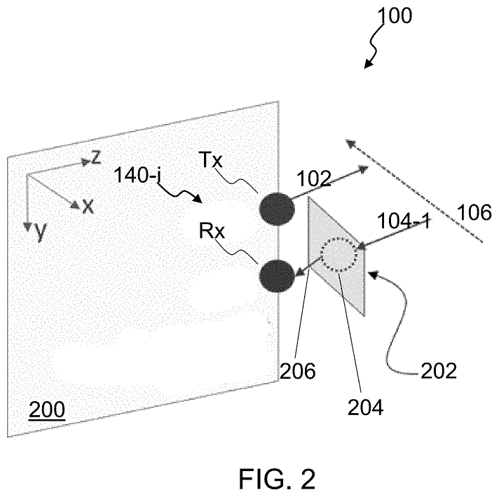

As an example, the PBD may be configured to divert the beam from the target (also denoted as returned beam) at a position (e.g. first light receiving position 204-1) displaced from the Tx interface along the x-direction (see FIG. 2), and move it to the optical input interface Rx on the PIC displaced from the optical output interface Tx along the y-direction (see FIG. 2 and FIG. 6). This way, optical output interface Tx and optical input interface Rx may be arranged on an edge of the PIC.

As an example, the PBD may be an optical element, e.g. a birefringent plate, e.g. made from a birefringent crystal. The PBD may be configured to divert or guide the beam received at the light receiving position 204, 204-1, 204-2—which may be a surface of the PBD, a specific amount based on the orientation of the “optic axis” of the PBD, and optical thickness of the PBD. The optic axis and optical thickness may be configured to achieve a predefined displacement in 2D space, e.g. to divert the offset beams 104-1, 104-2 to a common optical input interface or to predefined optical input interfaces. The PBD may be placed external to the PIC in the optical path of the optical beams 102, 104, 104-1, 104-2. The PBD may be configured to work on all optical channels with the same optical displacement, as an example. The PBD may be formed as one piece for all optical channels, or, alternatively, as one piece for each of the optical channels of the LIDAR system. The PBD may physically extend to more than one side relative to the optical output interfaces Tx (illustrated in FIG. 1). As an example, the optical output interface(s) Tx may be arranged along a center line of the PBD, e.g. for bidirectional scanning. For bidirectional scanning, the diversion 206 may be different on either side of the output interfaces Tx. Thus, for bidirectional scanning, the PBD may be a segmented PBD with PBD segments arranged symmetrical to the center line, and the center line being perpendicular to the scanning direction, as an example. This way, the LIDAR system supports bidirectional or multidirectional scanning directions 106.

FIG. 2 illustrates a schematic diagram of optical input/output interfaces of a LIDAR system 100. The LIDAR system 100 may include one or more optical channels 140-i. FIG. 2 illustrates the working principle of one optical channel 140-i in case of one or more optical channels 140-i. Further illustrated are the optical output interface Tx and the optical input interface Rx of a PIC 200 of the LIDAR system. The LIDAR system 100 emits light 102 in a first direction (in FIG. 2 illustrated as z-direction) and receives at least a part of the light 104-1 from the scene back reflected in the (negative) z-direction. Here, the offset in the first direction illustrates the point-ahead error.

The emitted light beam 102 scans the scene, e.g. a via a scan mirror of the LIDAR system 100, in a second direction (in FIG. 2 illustrated as (negative) x-direction). The LIDAR system 100 receives the back reflected light beam 104-1 at a light receiving position 204 that is offset in the second direction ((positive) x-direction) relative to the optical output interface. The point-ahead error and/or the temporal skew, as described above, may cause the offset between the optical output interface Tx and the light receiving position 104-1. The arrangement of the light receiving position 204 relative to the optical output interface Tx may correlate to the scanning direction, and, thus, the arrangement illustrated in FIG. 2 is only an illustrative example.

Further illustrated is a PBD 202 of the LIDAR system 100. The PBD 202 may be a birefringent crystal that is configured to divert 206 the beam of the returned light 104-1 to the optical input port Rx of the photonic integrated circuit 200. The optical input port Rx may be arranged adjacent to the optical output interface Tx on the PIC 200, e.g. displaced in third direction (in FIG. 2 illustrated as y-direction). As an example, the optical output interface Tx and the optical input interface Rx may be arranged in a common plane, e.g. the y-z-plane. Thus, in this example, the PBD 202 displaces the returned beam 104-1 in y-direction to the optical input interface Rx of the PIC 200.

In other words, FIG. 2 schematically illustrates the optical input/output structure (also denoted as input/output interfaces or I/O-interfaces) of a LIDAR system 100.

The PBD 202 converts an x-displacement of the returned signal 104-1 due to a fast scan 106 into a y-displacement (fast scan in the sense of that it would otherwise be interpreted as non-offset returned signal 104). This way, I/O interfaces Tx, Rx may be located along a common edge of the PIC.

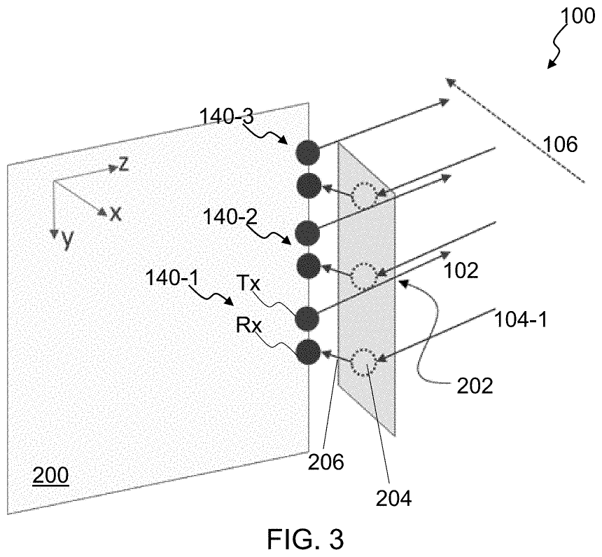

FIG. 3 illustrates a schematic diagram of optical input/output interfaces of a LIDAR system 100. FIG. 3 illustrates an example of a LIDAR system having a plurality of optical channels 140-1 to 140-N (in FIG. 3, three optical channels 140-1, 140-2, 140-3 are illustrated—here, N is equal to 3 or larger than 3). The optical channels 140-1, 140-2, 140-3 may be identical or different, e.g. configured for light of the same or different wavelengths and/or the same or different directions of light emission. However, the working principle of the optical channels 140-1, 140-2, 140-3 may correspond to the working principle described in FIG. 2.

In the example shown in FIG. 3, the optical output interfaces Tx and the optical input interfaces Rx are arranged on a single common positioning line. The positioning line may be oriented along the third direction, e.g. the y-axis, as an example. However, the arrangement shown in FIG. 3 is only an illustrative example. The positioning line may be a physical structure, e.g. an edge or waveguide structure of a PIC 200. The edge or waveguide structure may include a facet or bevel forming the optical input/output interfaces, as an example.

Further, in the example illustrated in FIG. 3, a common PBD 202 displaces 206 the beams of each optical channel 140-1, 140-2, 140-3.

In other words, FIG. 3 may schematically illustrate optical I/O interfaces Tx, Rx of a LIDAR system 100, e.g. of a plurality of optical channels 140-N illustrated in FIG. 2. Here, as an example, a single PBD 202 with an optic axis and thickness works for all optical channels 140-1, 140-2, 140-3 with the same x-displacement of the returned beams 104, 104-1, 104-2.

Alternatively, or in addition, e.g. in case the application of the LIDAR system 100 requires multiple photo detectors addressing the lagging return signals 104-1, 104-2, more than one positioning along the PIC may be considered.

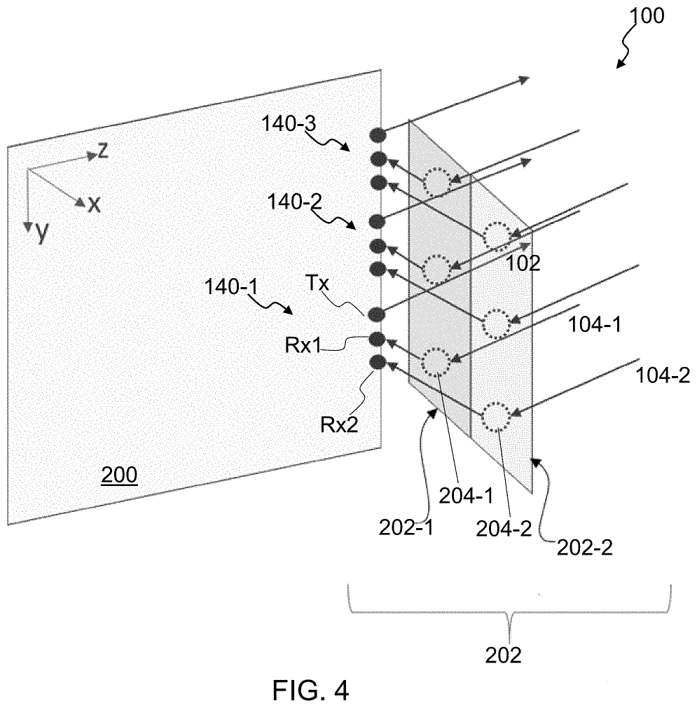

As an example, the LIDAR system may include a segmented PBD 202, as illustrated in FIG. 4. Here, different segments 202-1, 202-2 of the segmented PBD 202 have different orientations of the optic axis and/or thickness in order to perform a predefined 2D→1D mapping.

In detail, FIG. 4 illustrates a schematic diagram of optical input/output interfaces of a LIDAR system. The working principle of the optical channels 140-1, 140-2, 140-3 corresponds to the working principle described above. FIG. 4 illustrates an example in which the PBD 202 includes a first PBD segment 202-1 and at least a second PBD segment 202-2. The first PBD segment 202-1 and the second PBD segment 202-2 may be different parts of a common segmented PBD 202, e.g. different crystallographic portions. Alternatively, the first PBD segment 202-1 and the second PBD segment 202-2 may be individual PBDs attached together.

The first PBD segment 202-1 may be adjusted for light returned from the scene from a first distance (also denoted as distance range, see also FIG. 8) and the second PBD segment 202-2 may be adjusted for light returned from the scene from a second distance larger than the first distance.

Light 104-1 from the first distance returns to a first light receiving position 204-1, and light 104-2 from the second distance returns to a second light receiving position 204-2. The second light receiving position 204-2 has a larger offset to the optical output interface Tx than the first light receiving position 204-1. The PBD 202 may diversion the returned lights 104-1, 104-2 to a common optical input interface Rx or to different optical input interfaces Rx1, Rx2, as illustrated in FIG. 4, via the segmented PBD 202.

In FIG. 4, a first PBD segment 202-1 and a second PBD 202-2 are illustrated. However, the segmented PBD 202 may include more than two PBDs, e.g. depending on the distance ranges to be considered.

The individual PBD segments 202-1, 202-2 may be adjusted for different ranges and/or directions of the returned light 104. As an example, the arrangement and number of PBD segments 202-1, 202-2 may depend on the scanning direction (see FIG. 1-FIG. 3), and the scanning direction may be adjustable. Thus, not each of the PBD segments of the segmented PBD may be usable at the same time, e.g. depending on the scanning direction 106.

Further, in the example illustrated in FIG. 4, PBD segments 202-1, 202-2 for each range may divert 204-1, 204-2 the beams of each optical channel 140-1, 140-2, 140-3 in a common manner. However, this is only an illustrative example, and the segments of the segmented PBD may be adjusted for different diversions and/or non-linear diversions.

In other words, FIG. 4 illustrates a use of a segmented PBD 202, e.g. here having a first PBD segment 202-1 and a second PBD segment 202-2, to consider returned lights 104, 104-1, 104-2 from different distance (ranges) that result in different spatial lateral separations (offsets) from the optical output interface Tx along the scan direction (here, the x-direction) 106.

Alternatively, or in addition, the segmented PBD 202 may be configured that the transition from one PBD segment to an adjacent PBD segment is gradually.

Illustratively, FIG. 4 schematically illustrates optical I/O interfaces TX, Rx of a LIDAR system 100 having (at least) a first lagging beam 104-1 and a second lagging beam 104-2 per Tx beam 102, as an example. However, the I/O interfaces TX, Rx can be extended to a returned beam without any lag (104), or lag along the negative x direction for the opposite scan direction 106. As an example, the segmented PBD may be applied to a bidirectional scan by positioning a segmented PBD on either side of an edge of the PIC. An returned beam 104 with no displacement compared to the emitted beam 102 can also be separated to a predefined optical input interface Rx channel to avoid back reflections, e.g. a cross-talk with the light 102 emitted from the optical output interface. Thus, the segmented PBD 202 may be configured to receive returned light 104, 104-1, 104-2 from different distance (ranges) in the scene, e.g. objects arranged in the respective distance (range) in the scene, that result in different spatial separations from the optical output interface Tx along the scan direction (here, the x-direction) 106.

In general, the polarization diversity optics may create optical aberrations, e.g. defocus and spherical aberrations, and the optic axis of the crystal can be adjusted regarding the location of optical input and output interfaces Tx, Rx, e.g. by recessing one or both of the waveguides coupled or including the optical input or output interfaces Tx, Rx along the axis of propagation, and/or by different amounts.

Further, sliding-window analysis, e.g. Sliding Window Fourier Transformation, may be used to process the signals received at the optical input interface(s) Rx1, Rx2. This way, the temporal skew described above can be considered.

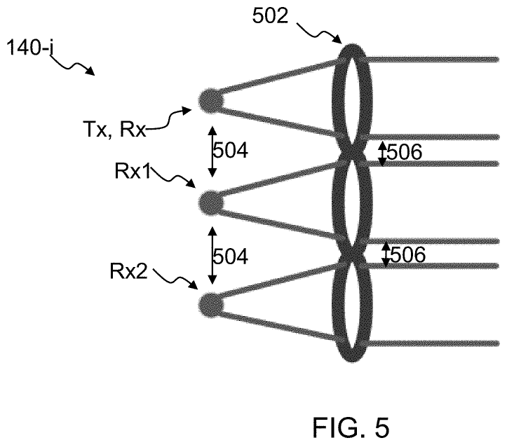

FIG. 5 illustrates a schematic diagram of optical input/output interfaces of a LIDAR system 100. An optical cross-talk may occur between the optical input/output interfaces Tx, Rx of the optical channels 140-i. A first spacing 504 between the optical input/output interfaces Rx/Tx may reduce the cross-talk. A microlens array (MLA) 502 in the beam paths of the transmitted light and/or returned light may result in a second spacing 506 smaller than the first spacing 504. This way, the fill factor may be increased, and thus efficiency may be improved.

As an example, the first spacing 504 may be constrained between the Tx/Rx interfaces of single optical channels 140-i. In case the optical channel(s) 140-i include more than one photo detector, each of the photo detectors may measure only a subset of target ranges. Thus, the first spacing 504 between the optical input interfaces Rx1, Rx2 may result in that ranges that fall in the gap are not efficiently measured. This effect may also occur between the optical output interface Tx or the respective optical input interface Rx and/or an adjacent optical input interface Rx1 of the respective optical channel 140-i.

The MLA 502 may be arranged in various positions in the optical beam paths, for example, between the optical input interface/optical output interfaces and the PBD 202, or between the PBD 202 and the object/scene.

In other words, in case of a physical gap 504 between receivers of an optical channel, light from the corresponding ranges may be not collected efficiently, leading to a loss in performance. The fill-factor of a receiver array or a transmitter and receiver array may be improved by incorporating a microlens array (MLA) in the optical path as shown in FIG. 5. The MLA 502 can achieve fill factors much closer to unity (>80%) and effectively collect light. The MLA 502 may be combined with a segmented PBD array into a single mechanical element, e.g. by a MLA-shaped PBD crystal or by attaching the MLA and the segmented PBD together. Thus, a lens array, e.g. an MLA 502, placed outside the PIC can “fill in” the gaps 504 between the optical interfaces on the PIC and improve the fill-factor of the collection array. This MLA 502 may be incorporated as part of the segmented PBD of FIG. 4. The pitch, focal length and other optical properties of the lenslets, e.g. individual elements of the MLA 502, may be uniform or non-uniform. The MLA 502 may be lithographically fabricated, e.g., using a high refractive index material such as silicon.

In other words, the polarization diversity optic enables efficient photon collection. However, microlenses (MLA) or other optical elements, e.g. a lens and/or a grating system can further improve the photon collection efficiency.

In detail, in the LIDAR system having a PIC and/or a plurality of optical input interfaces Rx, a minimum physical separation may be required between optical interfaces Rx, Tx, e.g. in order to avoid cross-talk between the interfaces Rx, Tx. The physical separation of the optical interfaces may be denoted as “imperfect fill factor”. The fill factor may refer to the ratio between the size of the receiver Rx, e.g. the optical interface at the PIC edge or surface, and the separation between adjacent receivers. For each optical channel 140-i, different Rx interfaces (also denoted as input interface or receiver) collect light from different subsets of ranges to any pixel.

FIG. 6 illustrates a schematic diagram of a LIDAR system 100. The LIDAR system 100 includes a photonic integrated circuit substrate 602, e.g. a semiconductor substrate, e.g. a silicon-based substrate. One or more optical channels 140-i of the LIDAR system 100 may include further optical components 650, e.g. a scan mirror in the light path between a grating structure and the outside of the LIDAR system 100. A lens may be arranged between the PIC 200 and the grating structure, and the PBD 202 may be arranged between the PIC 200 and the lens. The lens may be any one of a converging lens, a collimating lens or a diverging lens. The lens may be at least one lenslet of the MLA of FIG. 5, as an example. The grating structure may be a transmission grating, a reflective grating, or a grism. The grating structure may be optically arranged to guide light from the optical output interface Tx of the PIC 200 to the outside of the LIDAR system 100 and from the outside of the LIDAR system 100 to an optical photo detector structure 612.

The LIDAR system 100 may further include a polarization diversity optic 640, e.g. a Faraday Rotator or a quarter wave plate (QWP), in the light path outside of the PBD 202. The polarization diversity optic 640 turns the polarization of the transmitted light 102 and the light 104 back reflected from the target. This way, the light received at PBD 202 has a different polarization than the transmitted light, and the PBD 202 can divert the back reflected light to the optical input interface Rx.

Using a multiple (M) wavelength laser source and the grating structure, the number of LIDAR channels may be increased by a factor of M for a given PIC 200 to achieve a desired high number (>100) of vertical resolution elements or pixels. Hence, a high-performance coherent LIDAR system 100 is achieved.

The one or more optical output interfaces Tx may emit electromagnetic radiation, e.g. ultra-violet light, visible light, infrared radiation, terahertz radiation or microwave radiation (denoted as “light” throughout this specification) to different parts of the scene of the LIDAR system, e.g. at the same time or subsequently, e.g. by the grating structure and/or the lens structure along one or more optical channels 140-i. This way, light emitted by the optical output interface Tx of the PIC 200 samples different portions of a target (not the same pixel) and/or different targets at the same time. Thus, light reflected 104 from the target and detected by a photo detector structure 612 of different optical channels 140-i contains information correlated to different portions of a target (not the same pixel) and/or different targets at the same time. In other words, a plurality of optical channels 140-i emit light into different directions in space using the grating. The target back reflects light 104, and, then, polarization diversity optics, as described above, transmits light 104, 104-1, 140-2 along one or more different paths to the optical input interface Rx. This way, a mapping between the emitted light 102 and the information of the target may be enabled from the returned light 104, 104-1, 104-2. As an example, a sampling rate of the LIDAR system 100 and, thus, a resolution, may be increased while at least maintaining or decreasing noise effects.

The photonic integrated circuit 200 may include one or more optical channels 140-i. Thus, as an example, multiple (i being an element of 1 to N, N>10) vertical optical channels operating in parallel may be provided. Hence, a high (>1M pixels/s) overall or effective data rate may be enabled.

The LIDAR system 100 may include a plurality of light sources (also denoted as (coherent) electromagnetic radiation source) each configured to emit electromagnetic radiation having a wavelength/frequency different to the wavelength/frequency of the other light sources. The light source provides the light 620 to an optical input structure of the PIC 602. Alternatively or in addition, the LIDAR system 100 may include one or more light source(s) configured to emit electromagnetic radiation 620 of different/multiple wavelengths/frequencies. An optical filter, e.g. a low pass, high pass, band pass or notch filter may select a wavelength/frequency of a plurality of wavelengths/frequencies of a single light source. This way, by using wavelength multiplexing of spatially parallel optical channels in a PIC 200/waveguide structures of PIC 200, the detrimental effects due to fluctuating targets and TOF limitations are mitigated, thus enabling a coherent LIDAR with high optical resolution, high data rate, and long-range detection to be achieved.

A waveguide structure 624 may be in the form of a strip line or micro strip line. However, a waveguide structure 624 may also be configured as a planar waveguide. The waveguide structure 624 may be configured to guide electromagnetic radiation emitted from a light source couple to the input 604 to the optical output interface Tx. The waveguide structure 624 may be formed from the material of the semiconductor photonic integrated circuit 602. Waveguide structures 124 may be optically isolated from each other. As an example, at least one waveguide structure 624 may be formed from semiconductor photonic integrated circuit 602.

Further illustrated in FIG. 6 is a use of a part of the light from a beam splitter 610 as input signal for a photo detector structure 612 in the optical channel 140-i. Here, the input signal may be used as local oscillator (LO) for determining a difference between the light 102 emitted from the optical output interface Tx of the PIC 200 and light 104 received from the optical input interface Rx at the photo detector structure 612. Temporal fluctuations of the emitted light 102 may be considered in the received light 104 for each light path 140-i individually, thus allowing the LIDAR system 100 to detect and discriminate the optical frequency of the received light.

The photo detector structure 612 of different optical channels 140-i may be optically isolated from each other and/or may be addressable independently from each other. In other words, the photo detector structures 612 of different optical channels may be configured to detect light from the outside of the PIC 200 independently from each other. However, the LO signal of an optical channel 140-i may be used for two or more photo detector structures. As an example, as illustrated in FIG. 4, light received at different optical input ports Rx1, Rx2 may be correlated to the same emitted light 102. Thus, in case individual photo detector structures determine the returned light 104, 104-1, 104-2 (see FIG. 4) independently from each other, each of the individual photo detector receives a LO signal from the optical splitter 610. Thus, the optical splitter 610 may have an optical splitting ratio of one input from the light source (coupled to the waveguide structure 624) to “x” outputs coupled to a respective photo detector structure (FIG. 6 shows only one photo detector structure 612). Here, “x” corresponds to the number of total PBD segments of the segmented PBD (FIG. 4 may only show some of the PBD segments that receive back reflected light in the illustrated scan direction 106). As an example, in case of more than one scan direction, there may be a first group of PBD segments that receive returned light while scanning in a first scanning direction but receive no returned light while scanning in a second scanning direction, and a second group of PBD segments that receive returned light while scanning in the second scanning direction but receive no returned light while scanning in the first scanning direction. As an example, the LIDAR system may be configured to scan bidirectional along the x-direction in FIG. 6 (out of/in to the illustrated plane), and PBD segments may be arranged on either side of the PIC 200, e.g. symmetrically regarding the PIC 200. Thus, LO signals may be provided for each of the PBD segments of the first group and the second group, and, hence, the optical splitter 610 may be configured to provide LO signals to each of the photo detector structures coupled to the optical input interfaces coupled to the PBD segments. Illustratively, the optical splitter may provide more LO signals than currently used in a scanning direction. Alternatively, two or more returned lights from the PBD segments may be coupled in to a common photo detector structure. As an example, the PBD segments may be configured to divert the light returned from different distance ranges in to a common optical input interface Rx. Alternatively, the PIC 200 may include a beam combiner coupled to the third waveguide structure 624-3 and to at least two optical input interfaces Rx1, Rx2 (see FIG. 4) to combine the light received at the optical input interfaces Rx1, Rx2 into a single beam for the photo detector structure 612.

Further, the PIC 200 may include an optical amplifier (SOA) coupled to the optical input interface Rx to amplify the returned light, e.g. of one or more PBD segments. This way, as an example, the signals from the PBD segments may be weighted.

The photonic integrated circuit 200 may include a semiconductor photonic integrated circuit 602. The semiconductor photonic integrated circuit 602 may have integrated therein at least one light receiving input 604 and at least one optical splitter 606 to branch light received at the at least one light receiving input 604 to one of one or more optical channels 140-i.

The semiconductor photonic integrated circuit 602 may be made of a semiconductor material, e.g. silicon. The semiconductor photonic integrated circuit 602 may be common substrate, e.g. at least for a plurality of optical channels. The term “integrated therein” may be understood as formed from the material of the substrate and, thus, may be different to the case in which elements are formed, arranged or positioned on top of a substrate. The term “located next” may be interpreted as formed in or on the same (a common) semiconductor photonic integrated circuit 602.

In each light path of the one or more optical channels 140-N, the photonic integrated circuit 200 may include at least one amplifier structure 608 to amplify the light in the light path to provide an amplified light. Each light path of the plurality of optical channels may include at least one optical output interface Tx configured to output the amplified light from the photonic integrated circuit 200. Each light path of the plurality of optical channels may include at least one photo detector structure 612 configured to receive light 104 from the outside of the photonic integrated circuit 200. The at least one photo detector structure 612 may be located next to the at least one light optical output interface Tx. The at least one photo detector structure 612 may be located next to the at least one optical output interface Tx, e.g. integrated in the common semiconductor photonic integrated circuit 602. The at least one light optical output interface Tx and the at least one photo detector structure 612 may be arranged on the same side of the photonic integrated circuit 200. The at least one photo detector structure 612 may include a photo diode and a beam combining structure (also denoted as optical combiner, optical beam combiner or optical mixer).

The beam combining structure is configured to merge at least two individual beams to a single beam. The beam combining structure may include a first input and a second input. The first input may be coupled to an optical splitter structure 610 and the second input may be coupled to optical input interface Rx. Alternatively, the second input may be coupled to a beam combiner combining the light of two or more optical input interfaces. As an example, referring to FIG. 4, Rx1 and Rx2 may transmit light to the same photo detector structure 612 via the second input. The output of the beam combining structure may effectively be optically split, e.g. into two individual beams, in case a balanced photodiode pair is used.

Illustratively, each light path 140-i includes at least one optical splitter structure, a photo detector structure 612, a first waveguide structure 624-1, a second waveguide structure 624-2 and a third waveguide structure 624-3.

Illustratively, a waveguide structure 624 transmits a light 616 having an arbitrary polarization, e.g. a linear polarization, to the optical splitter structure. The optical splitter structure is configured to split the light received at a receiving input partly into light of a first linear polarization and light of a second linear polarization. As an example, the optical splitter 610 transmits light of one of the lights of first linear polarization or of the second linear polarization towards the optical output interface Tx of the PIC 200 and the optical splitter 610 transmits the light having the other linear polarization towards the photo detector structure 612.

As an example, the first polarization may be oriented parallel to the surface of the substrate 602 and the second polarization may be oriented perpendicular to the surface of the substrate 602. However, the opposite case of orientation or any other orientation may also be possible so long as the first linear polarization and the second linear polarization are perpendicular to each other. Further, the light 616 at the input of the optical splitter structure 610 and the light outputted from the optical output interface Tx may have the same linear polarization, and, thus, the light towards the photo detector structure 612 may have a linear polarization orthogonal to the polarization of the light at the input of the optical splitter structure 612 and orthogonal to the polarization of the light the optical output interface Tx is outputting. Alternatively, the light 616 at the input of the optical splitter structure and the light transmitted to the photo detector structure 612 may have the same linear polarization, and, thus, the light outputted from the optical output interface Tx may have a linear polarization orthogonal to the polarization of the light at the input of the optical splitter structure and orthogonal to the polarization of the light transmitted to and received by the photo detector structure. Alternatively, the orientation of a linear polarization of the light received from the optical splitter structure may be different to the orientation of the first linear polarization and the second linear polarization.

Illustratively, the optical splitter structure may be an optically functional system including one more optical components. The one optical component alone, or the two or more optical components together, alter the light received at the receiving input of the optical splitter structure into a first light path section and a second light path section. Each of the first light path section and the second light path section supports linear polarized light. However, the linear polarized light of the first light path section is orthogonally polarized to the light of the second light path section.

As an example, the optical splitter structure may include an optical splitter 610 and a polarization rotator 630-1. However, the optical splitter 610 and the polarization rotator 630-1 may be configured as separate components. Alternatively, the optical splitter 610 and the polarization rotator 630-1 may be integrated or formed by a single optical component, e.g. based on total internal reflection, birefringence, a Faraday rotation or a combination thereof. The polarization rotator 630-1 may be optically arranged between the splitter 610 and the optical output interface Tx along the first light path section.

The optical splitter 610 may be configured to branch light 616 received from at least one light receiving input (in FIG. 6 the SOA 608 acts as input) to a first light path section and a second light path section. The light receiving input (608) may be configured to be coupled (at least indirectly) to at least one coherent electromagnetic radiation source.

The polarization rotator 630-1 may be arranged before, after, along or integrated in the first waveguide structure 624-1. Alternatively or in addition, the polarization rotator may be arranged before, after, along or integrated in the second waveguide structure 624-2, and, thus, in the second light path section or at least partially in the second light path section. Alternatively or in addition, the polarization rotator 630-2 may be arranged before, after, along or integrated in the third waveguide structure 624-3, and, thus, in the third light path section or at least partially in the third light path section. In other words, the polarization rotator may be arranged or integrated in one or more light path sections of a light path. As an example, the polarization rotator 630-1, 630-2 may be arranged or formed in the first light path section and the third light path section, e.g. arranged before, after, along or integrated in the first waveguide structure 624-1 and the third waveguide structure 624-3.

The polarization rotator is configured to turn the polarization, e.g. from a first linear polarization to a second linear polarization before the photo detector structure 612. The second linear polarization is orthogonal to the first polarization. The polarization rotator 630-1, 630-2 may be a Faraday rotator, a quarter wave plate, a birefringent structure or a total internal reflection structure, as an example.

Illustratively, the photo detector structure 612 may be an optically functional system including one more optical components. The one optical component alone, or the two or more optical components together are configured to receive light from the optical splitter structure 610, e.g. through the second waveguide structure 624-2, (also denoted as light of the second light path section) and from the outside of PIC 200, e.g. through the third waveguide structure 624-3, (also denoted as light of the third light path section) and merge (also denoted as combine) these lights into a single merged light beam or, for example in case a balanced photodiode pair is used, into two or more merged beams with known phase relation. The light of the second light path section and the light of the third light path section are coherent and have matching modes and, thus, may interfere. The light of the third light path section may be correlated to the light of the second light path section. The merged light beam includes the desired information of the LIDAR system, e.g. the distance range or range rate of the back reflecting target. The merged light beam may include desired information in the form of a time-dependent interference pattern.

As an example, the photo detector structure 612 may include a beam combining structure (not illustrated) having the first input and the second input of the photo detector structure 612 configured to merge the light of the second waveguide structure 624-2 received at the first input of the photo detector structure 612 and the light of the third waveguide structure 624-3 received at the second input of the photo detector structure 612 into a single merged beam. Light in the second waveguide structure 624-2 and light in the third waveguide structure 624-3 may be coherent and have matching modes and, thus, may interfere with each other in the beam combining structure. This way the photo diode of the photo detector structure 612 coupled to beam combining structure may determine a signal corresponding to the interference signal. The interference signal may include time-dependent intensity fluctuations corresponding to the structure of the scanned target 702, 704 (see FIG. 1). Alternatively, another light path of the plurality of optical channels may provide the light at the second input of the photo detector structure.

The first light path section may further include a first waveguide structure 624-1 and an optical output interface Tx of the PIC 200. The first waveguide structure 624-1 may be configured to guide light of the first linear polarization. The optical output interface Tx (also denoted as Tx) of the PIC 200 may be configured to emit light to the outside of the PIC 200.

The second light path section may further include a second waveguide structure 624-2 and a photo detector structure 612. The second waveguide structure 624-2 may be configured to guide light of the second linear polarization. As an example, the second waveguide structure 624-2 optically couples the optical splitter 610 of the optical splitter structure with a first input of the photo detector structure 612. This way light from the optical splitter 610 may act as a local oscillator (LO) signal for the photo detector structure 612.

The third waveguide structure 624-3 optically couples the optical input interface Rx with the second input of the photo detector structure 612. Alternatively, or in addition, the photo detector structure 612 may include a beam combining structure (not illustrated) having the first input and the second input of the photo detector structure 612 configured to merge the light of the second waveguide structure 624-2 received at the first input of the photo detector structure 612 and the light of the third waveguide structure 624-3 received at the second input of the photo detector structure 612 into a single beam. Light in second waveguide structure 624-2 and in the third waveguide structure 624-3 may be coherent and, thus, may interfere with each other in the beam combining structure. This way the photo diode of the photo detector structure 612 may determine a signal corresponding to the interference signal.

The polarizing beam displacer (PBD) 202 may comprise a birefringent crystal arranged with its optic axis tilted with regard to the optical axis of the incoming light path. By doing this, the coupling efficiency may be increased and the aberrations may be reduced. As an example, the optic axis of the PBD 202 may be arranged at an angle below 10° with respect to the optical axis of the incoming light path instead of a default value of 45°. However, the specific tilt angle depends on the optical properties of further optical components along the light path. The tilt angle may be determined by a numerical method.

The polarization diversity optic 640 may include or be a quarter or half wave plate. The polarization diversity optic 640 may further include a birefringent plate. The polarization diversity optic may further include a displacement structure, e.g. a recess or protrusion along the light path, configured to spatially divert the returned light 104 input to the optical input interface Rx regarding the emitted light 102. This way, optical path length differences may be adjusted or considered.

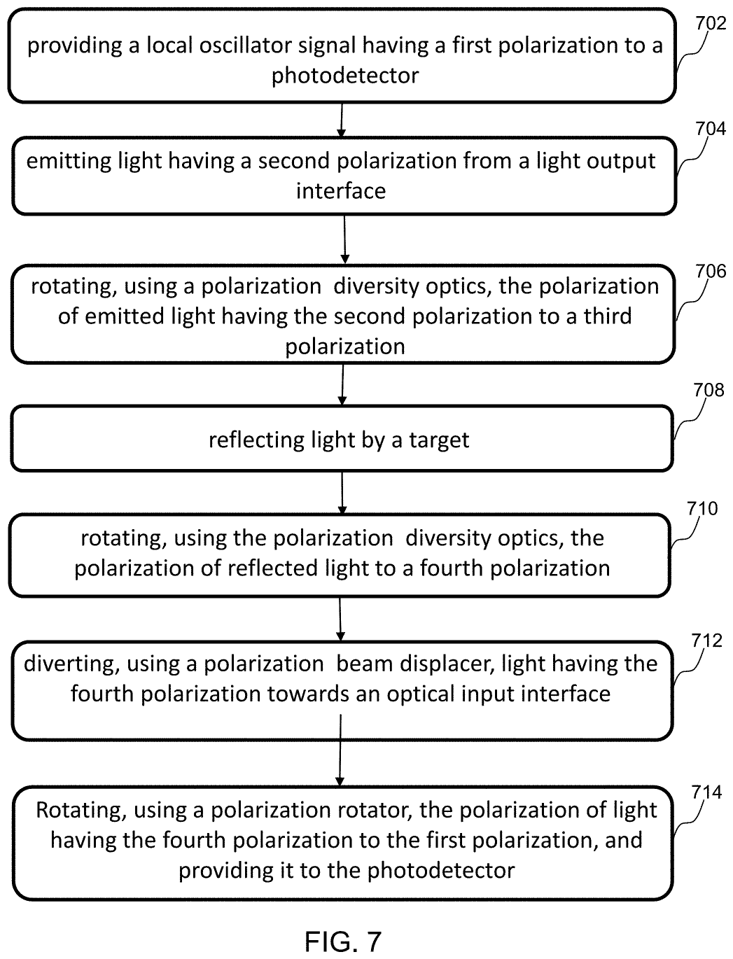

FIG. 7 illustrates, e.g. in conjunction with FIG. 6, an exemplary flow chart of the polarization state of light in an optical channel of the LIDAR system. In the following explanation, the polarization direction is only meant to distinguish the polarization states from each other, and may or may not correspond to any one of the polarization states mentioned before.

The light provided 702 to the photodetector 612, e.g. the LO signal, using the optical beam splitter 610 may have a first polarization. The optical output interface Tx may emit light having a second polarization. The second polarization may be the same or different to the first polarization. In this example, the second polarization is different from the first polarization.

The polarization diversity optic rotates 706 the polarization of the emitted light having the second polarization to a third polarization.

The target in the scene of the LIDAR system 100 back reflects 708 the light to the polarization diversity optics.

The polarization diversity optics rotates 710 the polarization of reflected light to a fourth polarization.

The polarization beam displacer spatially diverts 712 light having the fourth polarization, e.g. divert relative to the transmitted light having the second polarization, towards the optical input interface due to the optical anisotropy of the polarization beam displacer and polarization difference between the second polarization and the fourth polarization. The fourth polarization is different from the second polarization and the third polarization.

A polarization rotator may rotate 714 the light received at the optical input interface having the fourth polarization to the first polarization, and provide the light to the photodetector. Thus, the light received at the optical input interface has the same polarization as the LO signal. Alternatively, the polarization of the emitted light or of the LO signal may be rotated instead, or in addition, to the light received at the optical input interface.

In other words, a method to operate a LIDAR system may include a providing 702 of a local oscillator signal having a first polarization to a photodetector; an emitting 704 a light beam having a second polarization from a light output interface; a rotating, using a polarization diversity optics, the polarization of emitted light having the second polarization to a third polarization; a reflecting light by a target; a rotating, using the polarization diversity optics, the polarization of reflected light to a fourth polarization; a diverting, using a polarization beam displacer, light having the fourth polarization towards an optical input interface; and a rotating, using a polarization rotator, the polarization of light having the fourth polarization to the first polarization, and providing it to the photodetector.

FIG. 8 illustrates a vehicle having a LIDAR system integrated therein, as an example. The vehicle 800 may be an unmanned vehicle, e.g. unmanned aerial vehicle or unmanned automobile. The vehicle 800 may be an autonomous vehicle. Here, the LIDAR system 100 may be used to control the direction of travel of the vehicle 800. The LIDAR system 100 may be configured for obstacle detection outside of the vehicle 800, as an example. Alternatively or in addition, the vehicle 800 may require a driver to control the direction of travel of the vehicle 800. The LIDAR system 100 may be a driving assistant. As an example, the LIDAR system 100 may be configured for obstacle detection, e.g. determining a distance and/or direction and relative velocity of an obstacle (target 802, 804, back reflecting the light to the LIDAR system 100) outside of the vehicle 800. The LIDAR system 100 may be configured, along one or more optical channels, to emit light 102 from one or more outputs Tx of the LIDAR system 100 and to receive light 104 reflected from the target(s) 802, 804 in one or more light inputs Rx of the LIDAR system 100. A first target 802 may be arranged in a first distance 806 to the LIDAR system 100 and a second target 804 may be arranged in a second distance 808, larger than the first distance, to the LIDAR system 100. Thus, light 104 from the first target 802 may have a lower return time than the light from the second target 804.

Alternatively, the LIDAR system 100 may be or may be part of a spectrometer or microscope.

In other words, referring to FIG. 1 to FIG. 8, the LIDAR system 100 may include a laser source configured to emit one or more optical beams 620; and at least one optical channel 140-i configured to emit the one or more optical beams 102 from an optical output interface Tx of the optical channel 140-i over a scene and capture reflections of the one or more optical beams 104 from the scene in an optical input interface Rx of the optical channel 140-i. The one or more optical beams 102 may be configured to scan in a first direction (x-direction). In other words, the LIDAR system emits the optical beams in a third direction (z-direction) and scans the beams in the first direction, e.g. using a scanning mirror. The temporal skew and/or point-ahead error occur in the first direction. The optical input interface Rx and the optical output interface Tx may be arranged along a second direction (y-direction) different from the first direction (x-direction). The optical channel 140-i may include a PBD 202 configured to guide (e.g. divert or displace) 206 reflections of the one or more beams 104 from a receiving position 204 arranged along the first direction (x-direction; due to temporal skew or point-ahead error) towards the optical input interface Rx. The optical input interface may be offset in the first direction and the second direction from the receiving position. The receiving position 204 and the optical output interface Tx may be laterally offset, e.g. in x-direction. The second direction (y-direction) may be perpendicular to the first direction (x-direction).

The PIC 200 may include the optical output interface Tx and the optical output interface Tx. The PIC 200 may include an edge extending along the second direction (y-direction), the edge may include the optical output interface Tx and/or the optical input interface Rx.

The polarization beam displacer 202 may include a birefringent plate. The optic axis of the polarization beam displacer 202 may be tilted regarding an optical center of the first direction (x-direction).

The LIDAR system may further include a polarization diversity optics configured to turn the polarization of at least the reflected light between the scene and the receiving position. The polarization diversity optics may include a Faraday rotator and a half wave plate, or a quarter wave plate.

The LIDAR system 100 may include at least a first optical channel 140-1 and a second optical channel 140-2 configured as described above. The optical input interface Rx of the first optical channel 140-1 may be arranged between the optical output interface Tx of the first optical channel 140-1 and the optical output interface Tx of the second optical channel 140-2. Alternatively, or in addition, the optical input interfaces Rx of the first optical channel 140-1 and the second optical channel 140-2 and/or the optical output interfaces Tx of the first optical channel 140-1 and the second optical channel 140-2 may be arranged along a common direction.

The polarization beam displacer 202 may include at least a first polarization beam displacing segment 202-1 configured for a first distance range 806 in the scene, and a second polarization beam displacing segment 202-2 configured for a second distance range 808 in the scene larger than the first distance range 806. The first polarization beam displacing segment 202-1 and the second polarization beam displacing segment 202-2 may be coupled to a common photo detector. Alternatively, the first polarization beam displacing segment 202-1 may be optically coupled to a first photo detector and the second polarization beam displacing segment 202-2 may be optically coupled to a second photo detector.

Alternatively, or in addition, the polarization beam displacer 202 may include at least a first polarization beam displacing segment configured for a first scanning direction of the scene, and a second polarization beam displacing segment configured for a second scanning direction of the scene, different from the first scanning direction. The first polarization beam displacing segment and the second polarization beam displacing segment may be coupled to a common photo detector. Alternatively, the first polarization beam displacing segment may be optically coupled to a first photo detector and the second polarization beam displacing segment may be optically coupled to a second photo detector

The first polarization beam displacing segment 202-1 and the second polarization beam displacing segment 202-2 may be spatially staggered.

The LIDAR system 100 may include a measurement system configured to divide the scene into a plurality of pixels, the measurement system may include a photo detector configured to detect a return signal from multiple pixels of the plurality of pixels as the one or more optical beams may be scanned across the scene. The measurement system may include a photo detector configured to determine the return signal and mix the return signal with one or more local oscillator beams to determine a range and/or range rate for each of the multiple pixels. A data processor may be configured to perform data processing from the return signal from the multiple pixels to determine a range and/or range rate for each pixel of the scene. The data processing may include a sliding-window data processing from the return signal from the multiple pixels to determine the range and/or range rate for each pixel of the scene. The sliding-window data processing may include a sliding-window Fourier transformation.

The laser source may be configured to vary the optical frequency of the one or more optical beams in accordance with a periodic frequency versus time function.

### EXAMPLES

The examples set forth herein are illustrative and not exhaustive.

Example 1 may be a light detection and ranging (LIDAR) system that may include a laser source configured to emit one or more optical beams; and at least one optical channel configured to emit the one or more optical beams from an optical output interface of the optical channel over a scene and capture reflections of the one or more optical beams from the scene in an optical input interface of the optical channel. The one or more optical beams configured to scan in a first direction, and wherein the optical input interface and the optical output interface may be arranged along a second direction different from the first direction. The optical channel may include a polarization beam displacer configured to guide reflections of the one or more beams from a receiving position arranged along the first direction towards the optical input interface.

In Example 2, the subject matter of Example 1 can optionally include that the receiving position and the optical output interface may be laterally offset.

In Example 3, the subject matter of Example 1 or 2 can optionally include that the second direction may be perpendicular to the first direction.

In Example 4, the subject matter of any one of Examples 1 to 3 can further optionally include a photonic integrated circuit that may include the optical output interface and the optical output interface.

In Example 5, the subject matter of any one of Examples 4 can optionally include that the photonic integrated circuit may include an edge extending along the second direction, the edge may include that the optical output interface and/or the optical input interface.

In Example 6, the subject matter of any one of Example 1 to 5 can optionally include that the polarization beam displacer may include a birefringent plate.

In Example 7, the subject matter of Example 6 can optionally include that the optic axis of the birefringent plate is tilted regarding an optical center of the first direction.

In Example 8, the subject matter of any one of Example 1 to 7 can optionally include a polarization diversity optics configured to turn the polarization of at least the reflected light between the scene and the receiving position.

In Example 9, the subject matter of Example 9 can optionally include that the polarization diversity optics may include a Faraday rotator and a half wave plate, a Faraday rotator, or a quarter wave plate.

In Example 10, the subject matter of any one of Example 1 to 9 can optionally include at least a first optical channel and a second optical channel configured according to optical channel of any one of Examples 1 to 9, wherein the optical input interface of the first optical channel is arranged between the optical output interface of the first optical channel and the optical output interface of the second optical channel.

In Example 11, the subject matter of any one of Example 1 to 9 can optionally include at least a first optical channel and a second optical channel configured according to optical channel of any one of Examples 1 to 9, wherein the optical input interfaces of the first optical channel and the second optical channel and/or the optical output interfaces of the first optical channel and the second optical channel are arranged along a common direction.

In Example 12, the subject matter of any one of Example 1 to 11 can optionally include that the polarization beam displacer may include at least a first polarization beam displacing segment configured for a first distance range in the scene, and a second polarization beam displacing segment configured for a second distance range in the scene larger than the first distance range.

In Example 13, the subject matter of Example 12 can optionally include that the first polarization beam displacing segment and the second polarization beam displacing segment are coupled to a common photo detector.

In Example 14, the subject matter of Example 12 can optionally include that the first polarization beam displacing segment is optically coupled to a first photo detector and the second polarization beam displacing segment is optically coupled to a second photo detector.

In Example 15, the subject matter of any one of Example 1 to 14 can optionally include that the polarization beam displacer may include at least a third polarization beam displacing segment configured for a first scanning direction of the scene, and a fourth polarization beam displacing segment configured for a second scanning direction of the scene, different from the first scanning direction. The third and fourth polarization beam displacing segments may be first or second polarization beam displacing segment on opposite side of the optical output interface of Example 12, as an example.

In Example 16, the subject matter of Example 15 can optionally include that the third polarization beam displacing segment and the fourth polarization beam displacing segment are coupled to a common photo detector.

In Example 17, the subject matter of Example 15 can optionally include that the third polarization beam displacing segment is optically coupled to a third photo detector and the fourth polarization beam displacing segment is optically coupled to a fourth photo detector.

In Example 18, the subject matter of any one of Example 12 to 17 can optionally include that the polarization beam displacing segments are spatially staggered.

In Example 19, the subject matter of any one of Example 1 to 18 can optionally include a measurement system configured to divide the scene into a plurality of pixels, the measurement system may include a photo detector configured to detect a return signal from multiple pixels of the plurality of pixels as the one or more optical beams are scanned across the scene.

In Example 20, the subject matter of Example 19 can optionally include that the measurement system may include a photo detector configured to determine the return signal and mix the return signal with one or more local oscillator beams to determine a range and/or range rate for each of the multiple pixels.

In Example 21, the subject matter of any one of Example 1 to 20 can optionally include a data processor configured to perform data processing from the return signal from the multiple pixels to determine a range and/or range rate for each pixel of the scene.

In Example 22, the subject matter of Example 21 can optionally include that the data processing may include a sliding-window data processing from the return signal from the multiple pixels to determine the range and/or range rate for each pixel of the scene.

In Example 23, the subject matter of Example 22 can optionally include that the sliding-window data processing may include a sliding-window Fourier transformation.

In Example 24, the subject matter of any one of Example 1 to 23 can optionally include that the laser source may be configured to vary the optical frequency of the one or more optical beams in accordance with a periodic frequency versus time function.

Example 25 is a vehicle having a light detection and ranging (LIDAR) system. The LIDAR system includes a laser source configured to emit one or more optical beams; at least one optical channel configured to emit the one or more optical beams from an optical output interface of the optical channel over a scene and capture reflections of the one or more optical beams from the scene in an optical input interface of the optical channel; wherein the optical channel is configured to scan the one or more optical beams in a first direction, and wherein the optical input interface and the optical output interface are arranged along a second direction different from the first direction, and wherein the optical channel includes a polarization beam displacer configured to guide reflections of the one or more beams from a receiving position arranged along the first direction towards the optical input interface.

In Example 26, the subject matter of Example 25 can optionally include that the LIDAR system is configured as an obstacle detection system of the vehicle.

In Example 27, the subject matter of Example 25 or 26 can optionally include that the LIDAR system is configured according to any one of Examples 1 to 24 or 28 to Example 28 is a means for light detection and ranging (LIDAR), including a beam emitter for emitting one or more optical beams; an optical channel for emitting the one or more optical beams from an optical output interface of the optical channel over a scene and capturing reflections of the one or more optical beams from the scene in an optical input interface of the optical channel; wherein the one or more optical beams scan a first direction, and wherein the optical input interface and the optical output interface are arranged along a second direction different from the first direction, and wherein the optical channel includes a polarization beam displacer for guiding reflections of the one or more beams from a receiving position arranged along the first direction towards the optical input interface.

In Example 29, the subject matter of Example 28 can optionally include that the receiving position and the optical output interface may be laterally offset.

In Example 30, the subject matter of Example 28 or 29 can optionally include that the second direction may be perpendicular to the first direction.

In Example 31, the subject matter of any one of Examples 28 to 30 can further optionally include a photonic integrated circuit that may include the optical output interface and the optical output interface.

In Example 32, the subject matter of any one of Examples 28 to 31 can optionally include that the photonic integrated circuit may include an edge extending along the second direction, the edge may include that the optical output interface and/or the optical input interface.

In Example 33, the subject matter of any one of Example 28 to 32 can optionally include that the polarization beam displacer may include a birefringent plate.

In Example 34, the subject matter of Example 6 can optionally include that the optic axis of the birefringent plate is tilted regarding an optical center of the first direction.

In Example 35, the subject matter of any one of Example 28 to 34 can optionally include a polarization diversity optics configured to turn the polarization of at least the reflected light between the scene and the receiving position.

In Example 36, the subject matter of Example 35 can optionally include that the polarization diversity optics may include a Faraday rotator and a half wave plate, a Faraday rotator, or a quarter wave plate.

In Example 37, the subject matter of any one of Example 28 to 36 can optionally include at least a first optical channel and a second optical channel configured according to optical channel of any one of Examples 28 to 36, wherein the optical input interface of the first optical channel is arranged between the optical output interface of the first optical channel and the optical output interface of the second optical channel.

In Example 38, the subject matter of any one of Example 28 to 36 can optionally include at least a first optical channel and a second optical channel configured according to optical channel of any one of Examples 28 to 36, wherein the optical input interfaces of the first optical channel and the second optical channel and/or the optical output interfaces of the first optical channel and the second optical channel are arranged along a common direction.

In Example 39, the subject matter of any one of Example 28 to 38 can optionally include that the polarization beam displacer may include at least a first polarization beam displacing segment configured for a first distance range in the scene, and a second polarization beam displacing segment configured for a second distance range in the scene larger than the first distance range.

In Example 40, the subject matter of Example 39 can optionally include that the first polarization beam displacing segment and the second polarization beam displacing segment are coupled to a common photo detector.

In Example 41, the subject matter of Example 39 can optionally include that the first polarization beam displacing segment is optically coupled to a first photo detector and the second polarization beam displacing segment is optically coupled to a second photo detector.

In Example 42, the subject matter of any one of Example 28 to 41 can optionally include that the polarization beam displacer may include at least a third polarization beam displacing segment configured for a first scanning direction of the scene, and a fourth polarization beam displacing segment configured for a second scanning direction of the scene, different from the first scanning direction. The third and fourth polarization beam displacing segments may be first or second polarization beam displacing segment on opposite side of the optical output interface, as an example.

In Example 43, the subject matter of Example 42 can optionally include that the third polarization beam displacing segment and the fourth polarization beam displacing segment are coupled to a common photo detector.

In Example 44, the subject matter of Example 42 can optionally include that the third polarization beam displacing segment is optically coupled to a third photo detector and the fourth polarization beam displacing segment is optically coupled to a fourth photo detector.

In Example 45, the subject matter of any one of Example 42 to 44 can optionally include that the polarization beam displacing segments are spatially staggered.

In Example 46, the subject matter of any one of Example 28 to 45 can optionally include a measurement system configured to divide the scene into a plurality of pixels, the measurement system may include a photo detector configured to detect a return signal from multiple pixels of the plurality of pixels as the one or more optical beams are scanned across the scene.

In Example 47, the subject matter of Example 46 can optionally include that the measurement system may include a photo detector configured to determine the return signal and mix the return signal with one or more local oscillator beams to determine a range and/or range rate for each of the multiple pixels.

In Example 48, the subject matter of any one of Example 28 to 47 can optionally include a data processor configured to perform data processing from the return signal from the multiple pixels to determine a range and/or range rate for each pixel of the scene.

In Example 49, the subject matter of Example 48 can optionally include that the data processing may include a sliding-window data processing from the return signal from the multiple pixels to determine the range and/or range rate for each pixel of the scene.

In Example 50, the subject matter of Example 49 can optionally include that the sliding-window data processing may include a sliding-window Fourier transformation.

In Example 51, the subject matter of any one of Example 28 to 50 can optionally include that the laser source may be configured to vary the optical frequency of the one or more optical beams in accordance with a periodic frequency versus time function.

Example 52 is a light detection and ranging (LIDAR) system, including an optical output interface of at least one optical channel configured to emit one or more optical beams provided from a laser source; an optical output interface of the optical channel configured to capture reflections of the one or more optical beams from the scene; wherein the optical input interface and the optical output interface are arranged along a second direction; wherein the optical channel is configured to scan the one or more optical beams in a first direction different from the second direction, and wherein the optical channel includes a polarization beam displacer configured to guide reflections of the one or more beams from a receiving position arranged along the first direction towards the optical input interface.

In Example 53, the subject matter of Example 52 can optionally include that the receiving position and the optical output interface may be laterally offset.

In Example 54, the subject matter of Example 52 or 53 can optionally include that the second direction may be perpendicular to the first direction.

In Example 55, the subject matter of any one of Examples 28 to 30 can further optionally include a photonic integrated circuit that may include the optical output interface and the optical output interface.

In Example 56, the subject matter of any one of Examples 28 to 55 can optionally include that the photonic integrated circuit may include an edge extending along the second direction, the edge may include that the optical output interface and/or the optical input interface.

In Example 57, the subject matter of any one of Example 52 to 56 can optionally include that the polarization beam displacer may include a birefringent plate.

In Example 58, the subject matter of Example 6 can optionally include that the optic axis of the birefringent plate is tilted regarding an optical center of the first direction.

In Example 59, the subject matter of any one of Example 52 to 58 can optionally include a polarization diversity optics configured to turn the polarization of at least the reflected light between the scene and the receiving position.

In Example 60, the subject matter of Example 59 can optionally include that the polarization diversity optics may include a Faraday rotator and a half wave plate, a Faraday rotator, or a quarter wave plate.

In Example 61, the subject matter of any one of Example 52 to 59 can optionally include at least a first optical channel and a second optical channel configured according to optical channel of any one of Examples 52 to 60, wherein the optical input interface of the first optical channel is arranged between the optical output interface of the first optical channel and the optical output interface of the second optical channel.

In Example 62, the subject matter of any one of Example 52 to 59 can optionally include at least a first optical channel and a second optical channel configured according to optical channel of any one of Examples 52 to 60, wherein the optical input interfaces of the first optical channel and the second optical channel and/or the optical output interfaces of the first optical channel and the second optical channel are arranged along a common direction.

In Example 63, the subject matter of any one of Example 52 to 62 can optionally include that the polarization beam displacer may include at least a first polarization beam displacing segment configured for a first distance range in the scene, and a second polarization beam displacing segment configured for a second distance range in the scene larger than the first distance range.

In Example 64, the subject matter of Example 63 can optionally include that the first polarization beam displacing segment and the second polarization beam displacing segment are coupled to a common photo detector.

In Example 65, the subject matter of Example 63 can optionally include that the first polarization beam displacing segment is optically coupled to a first photo detector and the second polarization beam displacing segment is optically coupled to a second photo detector.

In Example 66, the subject matter of any one of Example 52 to 65 can optionally include that the polarization beam displacer may include at least a third polarization beam displacing segment configured for a first scanning direction of the scene, and a fourth polarization beam displacing segment configured for a second scanning direction of the scene, different from the first scanning direction. The third and fourth polarization beam displacing segments may be first or second polarization beam displacing segment on opposite side of the optical output interface of Example 12, as an example.

In Example 67, the subject matter of Example 66 can optionally include that the third polarization beam displacing segment and the fourth polarization beam displacing segment are coupled to a common photo detector.

In Example 68, the subject matter of Example 66 can optionally include that the third polarization beam displacing segment is optically coupled to a third photo detector and the fourth polarization beam displacing segment is optically coupled to a fourth photo detector.

In Example 69, the subject matter of any one of Example 62 to 68 can optionally include that the polarization beam displacing segments are spatially staggered.

In Example 70, the subject matter of any one of Example 52 to 69 can optionally include a measurement system configured to divide the scene into a plurality of pixels, the measurement system may include a photo detector configured to detect a return signal from multiple pixels of the plurality of pixels as the one or more optical beams are scanned across the scene.

In Example 71, the subject matter of Example 70 can optionally include that the measurement system may include a photo detector configured to determine the return signal and mix the return signal with one or more local oscillator beams to determine a range and/or range rate for each of the multiple pixels.

In Example 72, the subject matter of any one of Example 52 to 71 can optionally include a data processor configured to perform data processing from the return signal from the multiple pixels to determine a range and/or range rate for each pixel of the scene.

In Example 73, the subject matter of Example 72 can optionally include that the data processing may include a sliding-window data processing from the return signal from the multiple pixels to determine the range and/or range rate for each pixel of the scene.

In Example 74, the subject matter of Example 73 can optionally include that the sliding-window data processing may include a sliding-window Fourier transformation.

In Example 75, the subject matter of any one of Example 52 to 74 can optionally include that the laser source may be configured to vary the optical frequency of the one or more optical beams in accordance with a periodic frequency versus time function.

Example 76 is a light detection and ranging (LIDAR) system, including an optical splitting means for providing a local oscillator signal having a first polarization to a photodetector; an optical output means for emitting a light beam having a second polarization; a polarization diversity means for rotating the polarization of emitted light having the second polarization to a third polarization, and for rotating the polarization of reflected light to a fourth polarization; a polarization beam displacement means for diverting light having the fourth polarization towards an optical input means; and a polarization rotator means for rotating the polarization of light having the fourth polarization to the first polarization, and for providing it to the photodetector.

In Example 77, the subject matter of Example 76 can optionally include a beam combiner means for mixing the light from the optical input means with the local oscillator signal.

The word “exemplary” is used herein to mean “serving as an example, instance, or illustration.” Any example or design described herein as “exemplary” is not necessarily to be construed as preferred or advantageous over other examples or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e. one or more. Any term expressed in plural form that does not expressly state “plurality” or “multiple” likewise refers to a quantity equal to or greater than one.

The terms “processor” or “controller” as, for example, used herein may be understood as any kind of technological entity that allows handling of data. The data may be handled according to one or more specific functions that the processor or controller execute. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “connected” can be understood in the sense of a (e.g. mechanical and/or electrical), e.g. direct or indirect, connection and/or interaction. For example, several elements can be connected together mechanically such that they are physically retained (e.g., a plug connected to a socket) and electrically such that they have an electrically conductive path (e.g., signal paths exist along a communicative chain).

While the above descriptions and connected figures may depict electronic device components as separate elements, skilled persons will appreciate the various possibilities to combine or integrate discrete elements into a single element. Such may include combining two or more components from a single component, mounting two or more components onto a common chassis to form an integrated component, executing discrete software components on a common processor core, etc. Conversely, skilled persons will recognize the possibility to separate a single element into two or more discrete elements, such as splitting a single component into two or more separate component, separating a chip or chassis into discrete elements originally provided thereon, separating a software component into two or more sections and executing each on a separate processor core, etc. Also, it is appreciated that particular implementations of hardware and/or software components are merely illustrative, and other combinations of hardware and/or software that perform the methods described herein are within the scope of the disclosure.

It is appreciated that implementations of methods detailed herein are exemplary in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A light detection and ranging (LIDAR) system, comprising:
a laser source configured to emit one or more optical beams;
at least one optical channel configured to emit the one or more optical beams from an optical output interface of the optical channel over a scene and capture reflections of the one or more optical beams from the scene in an optical input interface of the optical channel;
wherein the optical channel is configured to scan the one or more optical beams in a first direction, and wherein the optical input interface and the optical output interface are arranged along a second direction different from the first direction, and
wherein the optical channel comprises a polarization beam displacer configured to guide reflections of the one or more beams from a receiving position arranged along the first direction towards the optical input interface.

2. The LIDAR system of claim 1,
wherein the receiving position and the optical output interface are laterally offset.

3. The LIDAR system of claim 1,
wherein the second direction is perpendicular to the first direction.

4. The LIDAR system of claim 1, further comprising a photonic integrated circuit comprising an edge extending along the second direction, the edge comprising the optical output interface and/or the optical input interface.

5. The LIDAR system of claim 1,
wherein the polarization beam displacer comprises a birefringent plate, wherein the optic axis of the birefringent plate is tilted regarding an optical center of the first direction.

6. The LIDAR system of claim 1, further comprising a polarization diversity optics configured to turn the polarization of at least the reflected light between the scene and the receiving position.

7. The LIDAR system of claim 1,
wherein the polarization beam displacer comprises at least a first polarization beam displacing segment configured for a first distance range in the scene, and a second polarization beam displacing segment configured for a second distance range in the scene larger than the first distance range.

8. The LIDAR system of claim 7,
wherein the first polarization beam displacing segment and the second polarization beam displacing segment are coupled to a common photo detector.

9. The LIDAR system of claim 7,
wherein the first polarization beam displacing segment is optically coupled to a first photo detector and the second polarization beam displacing segment is optically coupled to a second photo detector.

10. The LIDAR system of claim 1,
wherein the polarization beam displacer comprises at least a first polarization beam displacing segment configured for a first scanning direction of the scene, and a second polarization beam displacing segment configured for a second scanning direction of the scene, different from the first scanning direction.

11. The LIDAR system of claim 10,
wherein the first polarization beam displacing segment and the second polarization beam displacing segment are coupled to a common photo detector.

12. The LIDAR system of claim 10,
wherein the first polarization beam displacing segment is optically coupled to a first photo detector and the second polarization beam displacing segment is optically coupled to a second photo detector.

13. The LIDAR system of claim 7,
wherein the first polarization beam displacing segment and the second polarization beam displacing segment are spatially staggered.

14. The LIDAR system of claim 1,
comprising a plurality of optical channels and a microlens array comprising a plurality of lenslets, wherein each optical channel of the plurality of optical channels comprises at least one lenslet of the microlens array.

15. The LIDAR system of claim 1, further comprising:
a measurement system configured to divide the scene into a plurality of pixels, the measurement system comprising a photo detector configured to detect a return signal from multiple pixels of the plurality of pixels as the one or more optical beams are scanned across the scene; and
a data processor configured to perform data processing from the return signal of the reflected beams to determine a range and/or range rate for each pixel of the scene.

16. The LIDAR system of claim 15,
wherein the data processing comprises a sliding-window data processing from the return signal from the multiple pixels to determine the range and/or range rate for each pixel of the scene, wherein the sliding-window data processing comprises a sliding-window Fourier transformation.

17. The LIDAR system of claim 16,
the laser source configured to vary the optical frequency of the one or more optical beams in accordance with a periodic frequency versus time function.

18. A vehicle having a light detection and ranging (LIDAR) system, the LIDAR system comprising:
a laser source configured to emit one or more optical beams;
at least one optical channel configured to emit the one or more optical beams from an optical output interface of the optical channel over a scene and capture reflections of the one or more optical beams from the scene in an optical input interface of the optical channel;
wherein the optical channel is configured to scan the one or more optical beams in a first direction, and wherein the optical input interface and the optical output interface are arranged along a second direction different from the first direction, and wherein the optical channel comprises a polarization beam displacer configured to guide reflections of the one or more beams from a receiving position arranged along the first direction towards the optical input interface.

19. The vehicle of claim 18, the LIDAR system configured as an obstacle detection system of the vehicle.

20. A means for light detection and ranging (LIDAR), comprising:
a beam emitter for emitting one or more optical beams;
an optical channel for emitting the one or more optical beams from an optical output interface of the optical channel over a scene and capturing reflections of the one or more optical beams from the scene in an optical input interface of the optical channel;
wherein the one or more optical beams scan a first direction, and wherein the optical input interface and the optical output interface are arranged along a second direction different from the first direction, and
wherein the optical channel comprises a polarization beam displacer for guiding reflections of the one or more beams from a receiving position arranged along the first direction towards the optical input interface.

21. The means for LIDAR of claim 20, further comprising:
a measurement system for dividing the scene into a plurality of pixels to detect a return signal from multiple pixels of the plurality of pixels as the one or more optical beams are scanned across the scene, and mix the return signal with one or more local oscillator beams to determine a range and/or range rate for each of the multiple pixels.

22. A light detection and ranging (LIDAR) system, comprising:
an optical output interface of at least one optical channel configured to emit one or more optical beams provided from a laser source;
an optical output interface of the optical channel configured to capture reflections of the one or more optical beams from the scene;
wherein the optical input interface and the optical output interface are arranged along a second direction;
wherein the optical channel is configured to scan the one or more optical beams in a first direction different from the second direction, and wherein the optical channel comprises a polarization beam displacer configured to guide reflections of the one or more beams from a receiving position arranged along the first direction towards the optical input interface.

23. The LIDAR system of claim 22, further comprising a measurement system for dividing the scene into a plurality of pixels to detect a return signal from multiple pixels of the plurality of pixels as the one or more optical beams are scanned across the scene, and mix the return signal with one or more local oscillator beams to determine a range and/or range rate for each of the multiple pixels.

24. A light detection and ranging (LIDAR) system, comprising:
an optical splitting means for providing a local oscillator signal having a first polarization to a photodetector;
an optical output means for emitting a light beam having a second polarization;
a polarization diversity means for rotating the polarization of emitted light having the second polarization to a third polarization, and for rotating the polarization of reflected light to a fourth polarization;
a polarization beam displacement means for diverting light having the fourth polarization towards an optical input means; and
a polarization rotator means for rotating the polarization of light having the fourth polarization to the first polarization, and for providing it to the photodetector.

25. The LIDAR system of claim 24, further comprising:
a beam combiner means for mixing the light from the optical input means with the local oscillator signal.
